(19) United States
(12) Patent Application Publication
(10) Pub. No.: US 2007/0144366 A1
(43) Pub. Date: Jun. 28, 2007

(54) Stamp, stamp base, and stamp set

(76) Inventor: Etsumi Ogino, Narita-shi (JP)

Correspondence Address: SEED INTELLECTUAL PROPERTY LAW GROUP PLLC, 701 FIFTH AVE, SUITE 5400, SEATTLE, WA, 98104, US

(21) Appl. No.: 11/347,795

(22) Filed: Feb. 3, 2006

(30) Foreign Application Priority Data
Dec. 26, 2005 (JP) 2005-372715

(51) Int. Cl. B41J 1/60

(52) U.S. Cl. 101/109

(57) ABSTRACT

A stamp characterized by the fact that it is prepared by bonding a rubber stamp part to a base with an adhesive sheet having an adhesive layer on both sides, with the adhesive layer on the side of said adhesive sheet for bonding with the rubber stamp part being made of a self-adhesive elastomer. Also, a type of a stamp set composed of one or several stamp bases and one or several rubber stamp parts, with the adhesive layer on one side of an adhesive sheet having an adhesive layer on both sides being bonded to the base, and with the adhesive layer on the side of said adhesive sheet not for bonding with the base being made of a self-adhesive elastomer.

### BACKGROUND OF THE INVENTION

1. Field of the Invention

The present invention pertains to a type of stamp for stamping, a type of stamp base, and a type of stamp set that is a combination of the stamp base and a rubber stamp part.

2. Description of the Related Art

A stamp typically is composed of a rubber stamp part and a base part for the user's hand, and it is used for stamping a mark with ink stored in a stamp pad.

The stamp pad has a size and shape corresponding to the size of the stamp. The stamp pads are colorful, and there are various commercially available stamp pads and inks in different colors.

Usually, a commercially-available stamp is prepared by bonding a rubber stamp part to a base made of wood or resin. However, large stamps are expensive, and a large container is needed to accommodate multiple stamps.

Recently, a scheme has been adopted in which the rubber stamp part and the base are separate from each other, with patterns for the stamp marks being formed by pressing commercial sheet rubber, while the base is sold separately. In this scheme, a large rubber sheet with many stamp mark patterns formed on it can be bought at a low price. The user can then cut the rubber sheet himself/herself to form the rubber stamp part that is then bonded to the separately-sold base for use. This is highly economical.

Usually, an adhesive or a bonding agent is used to bond the rubber stamp part to the base. After the rubber stamp part and base are bonded to each other, the obtained stamp is used as is.

On the other hand, in order to use plural rubber stamp parts with only one base, one may peel off the rubber stamp part from the base of the stamp, and bond another rubber stamp part to the base for use. However, it is difficult to peel off the adhesive or bonding agent, and after peeling, the parts are sticky so that it is difficult to use them again.

### BRIEF SUMMARY OF THE INVENTION

The purpose of the present invention is to solve the aforementioned problems of the prior art by providing a type of stamp characterized by the fact that the rubber stamp part and the base can be separated easily, and the separated base can be used for many rubber stamp parts, as well as a type of base for said stamp.

According to the present invention, by using one or several stamp bases and rubber stamp parts as a set, it is possible to provide a stamp set including a variety of combinations of the stamp bases and rubber stamp parts for use.

That is, the present invention provides a type of stamp characterized by the fact that it is prepared by bonding a rubber stamp part and a base with an adhesive sheet having an adhesive layer on both sides, with the adhesive layer on the side of said adhesive sheet for bonding with said rubber stamp part being made of a self-adhesive elastomer.

The adhesive sheet consists of a resin layer and two adhesive layers, and the combination can be one of the following: adhesive layer made of a bonding agent/resin layer/adhesive layer made of a self-adhesive elastomer, adhesive layer made of an adhesive/resin layer/adhesive layer made of a self-adhesive elastomer, and adhesive layer made of a self-adhesive elastomer/resin layer/adhesive layer made of a self-adhesive elastomer.

The self-adhesive elastomer may be a self-adhesive polyurethane elastomer.

The adhesion between said base and the adhesive sheet can be greater than that between the rubber stamp part and the adhesive sheet.

The rubber stamp part and adhesive sheet can be bonded or separated by hand.

If said adhesive layer made of the self-adhesive elastomer becomes soiled, the original adhesion can be recovered by washing it.

The rubber stamp part, adhesive sheet and base can be transparent.

An indicator indicating the application position of the stamp mark can be provided on said transparent base.

Also, the present invention provides a type of stamp base characterized by the fact that it is prepared by bonding the adhesive layer on one side of an adhesive sheet having an adhesive layer on both sides on a base, and the adhesive layer on the side of said adhesive sheet not for bonding with the base is made of a self-adhesive elastomer.

In addition, the present invention provides a type of stamp set characterized by the fact that the stamp set is composed of one or several stamp bases, each of which is prepared by bonding the adhesive layer on one side of double-sided adhesive sheet to the base, with the adhesive layer on the side of said adhesive sheet not used for bonding with the base being made of a self-adhesive elastomer, and one or several rubber stamp parts.

The present invention can provide a type of stamp characterized by the fact that the rubber stamp part and the base can be separated easily and neatly, and the separated base can be used for any of several rubber stamp parts. The present invention also provides a type of stamp base for said stamp.

Also, the present invention provides a type of stamp set characterized by the fact that by using one or several stamp bases and rubber stamp parts as a set, it is possible to use a variety of combinations of the stamp bases and rubber stamp parts.

### BRIEF DESCRIPTION OF THE SEVERAL VIEWS OF THE DRAWINGS

FIG. 1 is a schematic cross section illustrating an embodiment of a stamp of the present invention.

FIG. 2 is a schematic cross section illustrating an embodiment of a stamp base of the present invention.

FIG. 3 is a schematic cross section illustrating an embodiment of a stamp set of the present invention.

FIG. 4 is a schematic cross section illustrating another embodiment of the stamp of the present invention.

### DETAILED DESCRIPTION OF THE INVENTION

In the following sections, embodiments of the present invention will be explained in more detail.

In general, the stamp of the present invention is prepared by bonding a rubber stamp part to a base with an adhesive sheet having an adhesive layer on both sides. The adhesive layer on the side of said adhesive sheet for bonding with the rubber stamp part is made of a self-adhesive elastomer.

FIG. 1 is a schematic cross section illustrating an embodiment of the stamp of the present invention. The illustrated stamp is prepared by bonding a rubber stamp part 1 to a base 2 with an adhesive sheet 3 having upper and lower adhesive layers 4, 5, respectively, on its two respective sides.

If not defined specifically, base 2 is of the conventional type. For example, it can be made of wood, transparent or opaque resin, elastic material, sponge material, etc. Among these, an acrylic resin or other transparent resin is preferred.

Characters, marks, graphs, patterns, etc., can be formed on rubber stamp part 1. The conventional patterns can be formed without any specific restriction. For example, it can be made of transparent or opaque resin or rubber, elastic material, metal, etc. In particular, a photosensitive resin or other transparent resin is preferred.

Said adhesive sheet 3 is a sheet having adhesive upper and lower layers 4, 5 applied on the two respective sides of a resin layer 6.

Said resin layer 6 may be made from a conventional resin sheet, such as a PET sheet, a polyester sheet, etc.

The upper adhesive layer 4 on the surface of the adhesive sheet 3 for bonding with the base 2 is made of an adhesive or a bonding agent. The adhesive or bonding agent may be of the conventionally-used type, such as an acrylic solvent type adhesive. The upper adhesive layer 4 can also be made of a self-adhesive elastomer.

The lower adhesive layer 5 on the surface of the adhesive sheet 3 for bonding with the rubber stamp part 1 is made of a self-adhesive elastomer. Here, “self-adhesive” means that the elastomer itself has adhesive properties. For example, a self-adhesive polyurethane elastomer can be used as the self-adhesive elastomer. The sheet made of self-adhesive elastomer can be transparent; dirt or dust attached to the adhesive surface can be removed by water washing, and the adhesion can be recovered after drying. Consequently, it can be used repeatedly. In addition, the adhesive substance does not migrate to the other side of the bond, so that the mating part is not soiled or scratched. As an example of the properties of a self-adhesive elastomer, the adhesion is 270 gf/14 mm (measurement method: pickup type tackmeter).

Examples of the constitution of upper adhesive layer 4/resin layer 6/lower adhesive layer 5 for the adhesive sheet 3 include the structure of bonding agent/resin layer/self-adhesive elastomer, the structure of adhesive/resin layer/self-adhesive elastomer, and the structure of self-adhesive elastomer/resin layer/self-adhesive elastomer. Examples of commercially-available adhesive sheets like this include TG SHEETS™ manufactured by Mochida Shoko K.K. (3 types: PET/self-adhesive polyurethane, adhesive/resin layer/self-adhesive polyurethane rubber, and self-adhesive polyurethane rubber/resin layer/self-adhesive polyurethane rubber). All of these adhesive sheets are transparent.

It is preferred that the adhesion of the upper adhesive layer 4 to the base 2 be greater than that of the lower adhesive layer 5 to the rubber stamp part 1. The base 2 and the rubber stamp part 1 bonded to the adhesive sheet 3 can be separated by hand.

With a conventional adhesive, once dirt or dust becomes attached to it, it is difficult to remove, and the adhesion is effectively lost. This is undesirable. According to the present invention, however, the self-adhesive elastomer for bonding the rubber stamp part 1 to the adhesive sheet 3 can be washed to restore the adhesion even when it becomes soiled. Consequently, it can be used repeatedly. This is an advantage.

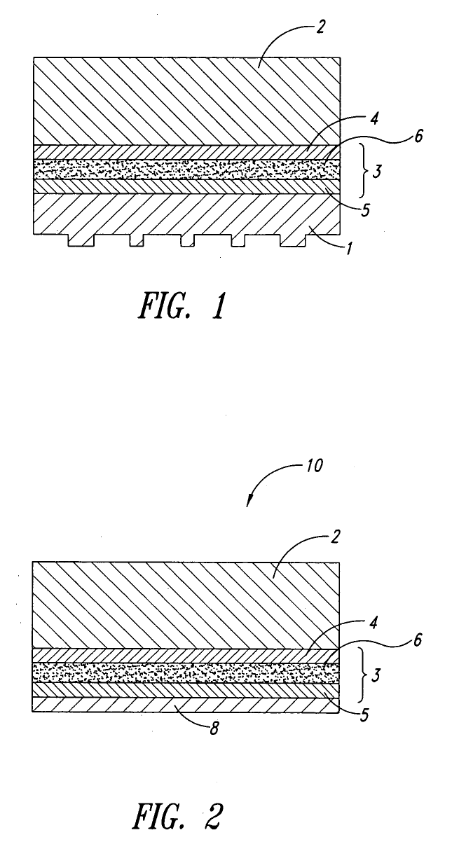

FIG. 2 is a schematic cross section illustrating an embodiment of the stamp base 10 of the present invention. For stamp base 10 of the present invention as shown in FIG. 2, the base 2 is bonded to the upper adhesive layer 4 on one side of the adhesive sheet 3, having an adhesive layer on both sides, just as was explained above. The lower adhesive layer 5, on the side of adhesive sheet 3, not for bonding with the base 2 is made of a self-adhesive elastomer. Reference number 8 represents a protective film that protects the lower adhesive layer 5 made of a self-adhesive elastomer.

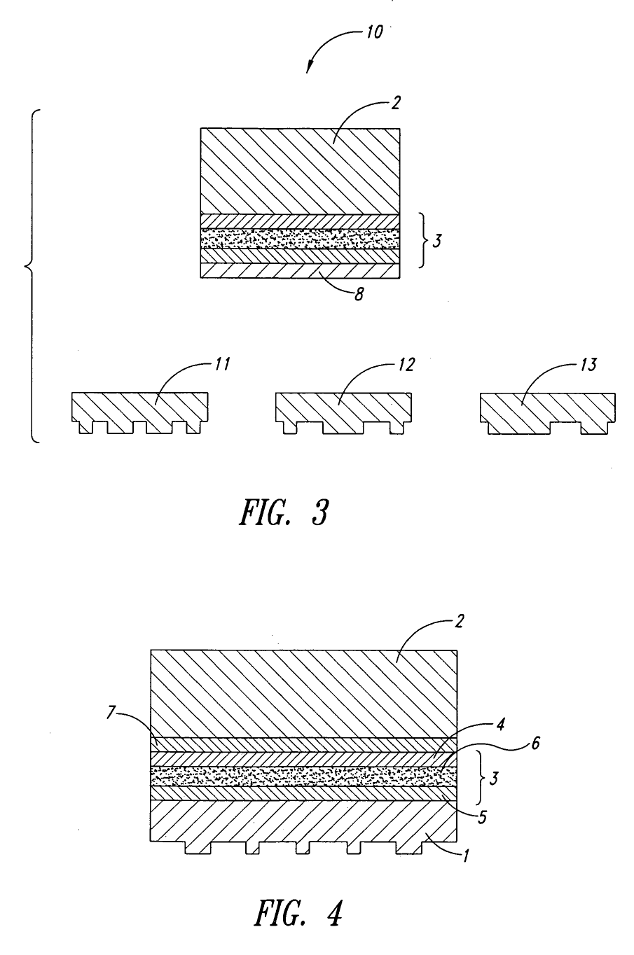

FIG. 3 is a schematic cross section illustrating an embodiment of the stamp set of the present invention. As shown in FIG. 3, the stamp set of the present invention includes one stamp base 10, such as that shown in FIG. 2, and three rubber stamp parts 11, 12, 13 for bonding to the stamp base 10. When the stamp set shown in FIG. 3 is adopted, after the stamp base 10 and rubber stamp 11 are bonded to each other and the stamp is used to apply the stamp mark, stamp base 10 and rubber stamp 11 can be separated, and then stamp base 10 and rubber stamp part 12 can be bonded for applying a different stamp mark. Using the same method, one can bond stamp base 10 to rubber stamp part 13 for applying yet another stamp mark. In this way, the stamp set allows two or more rubber stamp parts to be repeatedly bonded to one stamp base 10 for applying stamp marks.

### EXAMPLES

In the following sections, the present invention will be explained in more detail with reference to application examples.

### Example 1

A stamp with the constitution shown in FIG. 1 is prepared.

A transparent acrylic resin sheet is used in manufacturing the base 2, and a transparent photosensitive resin is used in manufacturing the rubber stamp part 1.

A transparent adhesive sheet 3 with a constitution of adhesive/PET/self-adhesive polyurethane rubber (TG SHEET™) manufactured by Mochida Shoko K.K. with a thickness of 1 mm) is used for bonding the base 2 on the side with the upper adhesive layer 4, and for bonding the rubber stamp part 1 on the side with the self-adhesive polyurethane rubber, to form a stamp.

The adhesive sheet 3 has differential adhesion. Here, “differential adhesion” means that the conventional adhesive on one side of the adhesive sheet 3 has a greater adhesion, while the self-adhesive polyurethane elastomer on the other side of the adhesive sheet has lower adhesion. Consequently, the adhesive side with greater adhesion is used for bonding to the base 2, for which easy separation would be problematic, while the adhesive side with the lower adhesion is used for bonding to the rubber stamp part 1 which needs to be easily separated.

Because the adhesive surface of the self-adhesive polyurethane elastomer on the side of the rubber stamp part 1 can be washed to restore the adhesion if it becomes soiled, it can be used semi-permanently. Also, the rubber stamp part 1 and the base 2 can be easily and neatly separated.

Also, as shown in FIG. 4, by bonding a grid line sheet 7, made of a transparent sheet prepared beforehand by printing a grid pattern on an acrylic resin sheet, it is possible to ensure correct positioning when bonding the rubber stamp part 1. Also, it enables applying the stamp mark at the correct position.

When the adhesive sheet 3 is made of a soft material, it works like a cushion, just like the sponge of the cushion material used in a conventional rubber stamp, so that when the rubber stamp is applied, bumps and dips on the paper surface can be absorbed so that a clean stamp mark can be made.

### Example 2

As shown in FIG. 2, a transparent adhesive sheet 3 with a constitution of adhesive/PET/self-adhesive polyurethane rubber (TG SHEET™ manufactured by Mochida Shoko K.K.) is used. A base 2 made of a transparent acrylic resin sheet is bonded on the sheet side with the adhesive to form a stamp base 10. A rubber stamp part 1 is prepared separately.

The size of the stamp base 2 is variable to allow preparation of plural types of bases. The size of the rubber stamp part 1 can also be changed to prepare several types. As a result, a set is obtained. Consequently, one can freely combine the stamp bases 2 and rubber stamp parts 1 to form a variety of stamps. In this way, since the stamp bases 2 and rubber stamp parts 1 are prepared separately, the freedom of selection is improved, and the size of the container can be reduced. The resulting cost reduction is significant.

### INDUSTRIAL APPLICATION FIELD

With the stamp of the present invention, it is easy to separate the rubber stamp part 1 and the base 2, and it is possible to use a single base with plural rubber stamp parts or one or more stamp bases and rubber stamp parts as a set. As a result, it is possible to combine the stamp bases and the rubber stamp parts as a stamp set.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A stamp comprising a base and a rubber stamp part, the rubber stamp part being bonded to the base with an adhesive sheet having an adhesive layer on both sides, the adhesive layer on the side of said adhesive sheet for bonding with said rubber stamp part being made of a self-adhesive elastomer.

2. The stamp of claim 1 wherein the adhesive sheet consists of a resin layer and two adhesive layers, and the combination is selected from one of the following: an adhesive layer made of a bonding agent/a resin layer/an adhesive layer made of a self-adhesive elastomer, an adhesive layer made of an adhesive/a resin layer/an adhesive layer made of a self-adhesive elastomer, and an adhesive layer made of a self-adhesive elastomer/a resin layer/an adhesive layer made of a self-adhesive elastomer.

3. The stamp of claim 1 wherein the self-adhesive elastomer is a self-adhesive polyurethane elastomer.

4. The stamp of claim 1 wherein the adhesion between said base and the adhesive sheet is greater than that between the rubber stamp part and the adhesive sheet.

5. The stamp of claim 1 wherein said rubber stamp part and said adhesive sheet can be bonded or separated by means of the user's hands.

6. The stamp of claim 1 wherein if said adhesive layer made of the self-adhesive elastomer is soiled, the original adhesion can be restored by washing it.

7. The stamp of claim 1 wherein said rubber stamp part, adhesive sheet and base are transparent.

8. The stamp of claim 7, further comprising an indicator indicating a position of application of the stamp mark is provided on said transparent base.

9. A stamp base comprising a base and an adhesive sheet, the base being bonded to an adhesive layer on one side of the adhesive sheet, and another adhesive layer on the side of the adhesive sheet not for bonding with the base is made of a self-adhesive elastomer.

10. A stamp set comprising at least one base and an adhesive sheet corresponding to each base, each base being bonded to an adhesive layer on one side of the adhesive sheet, with the adhesive layer on another side of the adhesive sheet not for bonding with the base being made of a self-adhesive elastomer, and further comprising at least one rubber stamp parts.
